(19) United States
(12) Patent Application Publication
(10) Pub. No.: US 2023/0388127 A1
(43) Pub. Date: Nov. 30, 2023

(54) ELECTRONIC DEVICE FOR ENCRYPTING BIOMETRIC DATA AND OPERATION METHOD OF ELECTRONIC DEVICE

(71) Applicant: SAMSUNG ELECTRONICS CO., LTD., Suwon-si (KR)

(72) Inventor: Moonsoo CHANG, Suwon-si (KR)

(21) Appl. No.: 18/448,972

(22) Filed: Aug. 14, 2023

Related U.S. Application Data
(63) Continuation of application No. PCT/KR2022/001530, filed on Jan. 27, 2022.

(30) Foreign Application Priority Data
Mar. 19, 2021 (KR) 10-2021-0035976

(51) Int. Cl. H04L 9/32; H04L 9/08

(52) U.S. Cl. CPC H04L 9/3231; H04L 9/0866

(57) ABSTRACT

An electronic device includes: a biometric sensor for acquiring biometric data; a processor including a general region, and a trusted region which is distinguished from the general region and in which a trusted application having a designated security level or higher is executed; a memory for storing encryption information (encryption data) related to registered biometric data; and a security processor which is physically separated from the processor, where the security processor is configured to encrypt the biometric data acquired by the sensor, and the processor is configured to: load the encrypted biometric data onto the trusted region, the biometric data being acquired from the security processor; extract feature information for biometric authentication from the encrypted biometric data; compare the feature information with the encryption information acquired from the memory; and perform the biometric authentication on the basis of a result of the comparison.

### TECHNICAL FIELD

Various embodiments of the disclosure relate to an electronic device that encrypts biometric data and an operation method of an electronic device, for example, an electronic device for encrypting biometric data and enhancing security of a biometric authentication system, and an operation method of an electronic device.

### BACKGROUND ART

Various types of security methods have been used in order to manage important documents or data. Particularly, as electronic technology has developed and a larger amount of data is capable of being stored in a small device, a desire for security technology has increased. As importance of security technology has increased, various types of security processing methods have been introduced. For example, security technology may be provided in various forms such as a scheme of using a security card for identifying and authenticating a user, a scheme of using a password periodically changed by a user, or a scheme of using biometric information having unique information different for each individual.

Enhanced security technology is also applied to various types of electronic devices, such as a smartphone or a laptop computer, in order to manage important information of an individual. For example, the electronic device may use biometric information having a feature different for each person, such as a fingerprint, a face, an iris, voice, lines of a palm, or veins, for identifying and authenticating a user.

As described above, security may be enhanced when the electronic device uses biometric information for user authentication. However, in case that biometric information is leaked or the like, damage thereof would be great. In case that biometric information is leaked once, it is difficult to change biometric information for each individual. In case that a fingerprint is leaked, it is almost impossible to change the leaked fingerprint of an individual. In case that an electronic device capable of performing wireless communication performs a security operation with another external device, for example, another terminal or a server by using biometric information, biometric information may be unintentionally leaked. The leakage of biometric information may cause unrestorable damage to users.

Therefore, a series of operations for identifying and authenticating a user using biometric information may be desirable to be performed in a secure environment that is safe from leakage to the outside.

Conventional technology embodies security technology such that operation is performed from an interval for reception of data that requires high security such as biometric information to an interval for authentication in a trusted execution environment (TEE) in a processor.

The TEE is a region separated from a general environment in hardware, and may secure a region inaccessible to an unauthenticated application. For example, a biometric authentication system performs a series of operations such as acquiring, processing, or determining data all in a TEE, and may store data in a memory including a secure region so as to prevent leakage of stored data itself. In addition, the electronic device performs control of a sensor that acquires biometric information in a TEE, and thus a general application is incapable of accessing biometric information and leakage may be prevented.

A biometric authentication scheme in a conventional TEE may perform, in a TEE, a series of operations, that is, an operation of acquiring, by an electronic device, biometric data from a biometric sensor, an operation of processing the acquired biometric data, an operation of decrypting encrypted registered biometric data stored in a memory, and an operation of matching the acquired biometric data and the registered biometric data. Therefore, the series of operations may be performed by using raw data related to biometric data. However, the TEE uses a processor of hardware the same as a processor used by a general application, and thus may have a concern about being a target of hacking.

Therefore, there have been developed secure devices based on hardware having a higher security level than that of security based on a TEE which has been conventionally used. The above-described technology may perform a series of operations of processing security data in hardware physically separated from a processor, and thus may completely prevent invasion from the outside. However, a biometric recognition method needs to process biometric data in the form of image data, and thus a large amount of calculation may be needed. Therefore, the technology processes data in a secure processor that shows a relatively low performance, and thus it is difficult to expect the performance the same as the performance of an existing processor.

### DISCLOSURE OF INVENTION

### Solution to Problem

An electronic device according to various embodiments of the disclosure may encrypt data that requires high security, such as biometric data, in separate hardware and may process the encrypted data in an existing processor, and thus may enhance security and may provide the performance the same as the performance of the existing processor.

For example, an electronic device according to various embodiments of the disclosure may include secure hardware physically separated from an application processor. The electronic device may provide technology that encrypts, in secure hardware, biometric data acquired from a biometric sensor and that processes the encrypted data in a trusted execution environment (TEE) of an application processor.

In addition, an electronic device according to various embodiments may perform a series of operations, such as processing, matching, or storing data by using encrypted data in separate hardware, so as to prevent leakage of raw data related to biometric data.

As described above, for user authentication using biometric, the technical subject matter is to provide an environment that is capable of completely defending biometric data against invasion from the outside, and is not to limit a data processing performance from the perspective of biometric data with a feature of having a large amount of information.

The technical subject matter of the disclosure is not limited to the above-mentioned technical subject matter, and other technical subject matters which are not mentioned may be understood by those skilled in the art based on the following description.

An electronic device according to various embodiments of the disclosure includes: a biometric sensor configured to acquire biometric data; a processor including a general region and a trust region that is distinguished from the general region and that is configured to execute a trust application requiring a security level higher than or equal to a designated security level; a memory configured to store encryption information (encryption data) related to registered biometric data; and a secure processor physically separated from the processor, and the secure processor is configured to encrypt the biometric data that the sensor acquires, and the processor is configured to load (loading), in the trust region, the encrypted biometric data acquired from the secure processor, to extract feature information for biometric authentication from the encrypted biometric data, to compare the feature information and the encryption information acquired from the memory, and to perform the biometric authentication based on a result of the comparison.

An operation method of an electronic device according to various embodiments of the disclosure includes: acquiring biometric data by a biometric sensor; encrypting the biometric data by a secure processor; acquiring the encrypted biometric data by a processor; loading, by the processor, the encrypted biometric data in a trust region where a trust application requiring a security level higher than or equal to a designated security level is executed; extracting, by the processor, feature information for biometric authentication from the encrypted biometric data; comparing, by the processor, the feature information and encryption information (encryption data) related to registered biometric data acquired from the memory; and performing, by the processor, the biometric authentication based on a result of the comparison.

### Advantageous Effects of Invention

An electronic device according to various embodiments may effectively protect biometric data used for biometric authentication from invasion from the outside.

In addition, an electronic device according to various embodiments may include separate secure hardware, and may encrypt biometric data in an environment physically separated from an application.

In addition, an electronic device according to various embodiments may effectively prevent leakage of raw data by performing user authentication using encrypted data.

In addition, although encrypted data is leaked, an electronic device according to various embodiments may change an encrypted key and may reproduce encryption data, thereby effectively maintaining a security system.

In addition, an electronic device according to various embodiments may process data encrypted in a secure processor in a main processor, thereby effectively avoiding limitation of a processing performance.

In addition, various effects directly or indirectly recognized from the disclosure may be provided.

### BRIEF DESCRIPTION OF DRAWINGS

Regarding the descriptions of drawings, identical or like reference numerals in the drawings denote identical or like component elements.

FIG. 1 is a block diagram illustrating an electronic device in a network environment according to various embodiments.

FIG. 2 is a block diagram of an electronic device according to various embodiments.

FIG. 3 is a flowchart illustrating a method of performing, by a processor, biometric authentication using biometric data encrypted by a secure processor, according to various embodiments.

FIG. 4A is a diagram illustrating operation performed among a biometric sensor, a secure processor, and/or a memory for biometric authentication according to various embodiments.

FIG. 4B is a diagram illustrating a configuration of an electronic device and a flow of data according to various embodiments.

FIG. 5A is a diagram illustrating operation performed among a biometric sensor, a processor, a secure processor, and/or a memory for biometric authentication according to various embodiments.

FIG. 5B is a diagram illustrating a configuration of an electronic device and a flow of data according to various embodiments.

FIG. 6 is a diagram illustrating operation performed among a biometric sensor, a processor, a secure processor, and/or a memory for biometric data registration according to various embodiments.

FIG. 7 is a diagram illustrating a configuration of an electronic device and a flow of data according to various embodiments.

### MODE FOR THE INVENTION

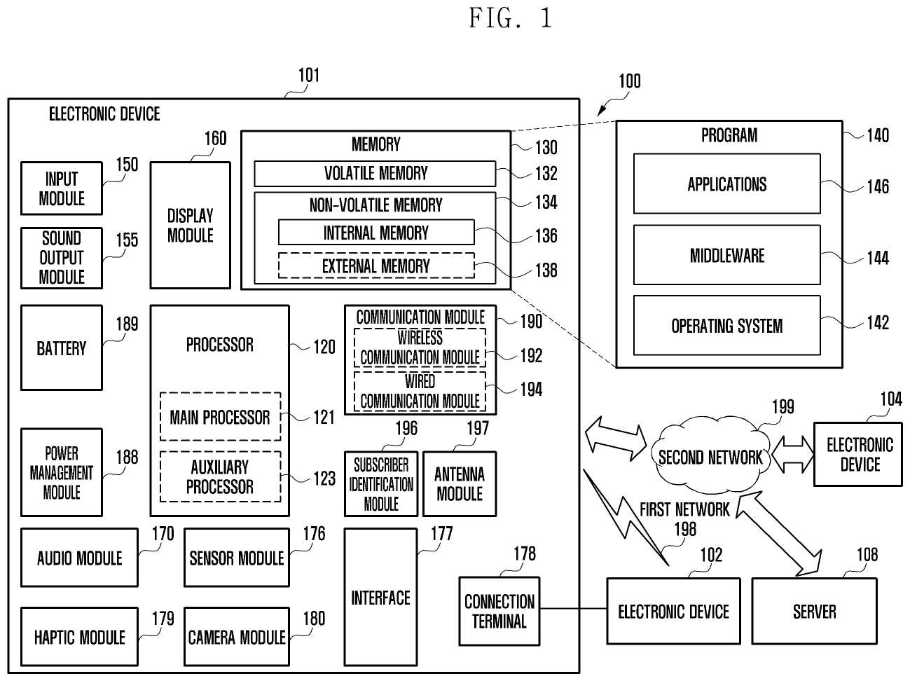

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

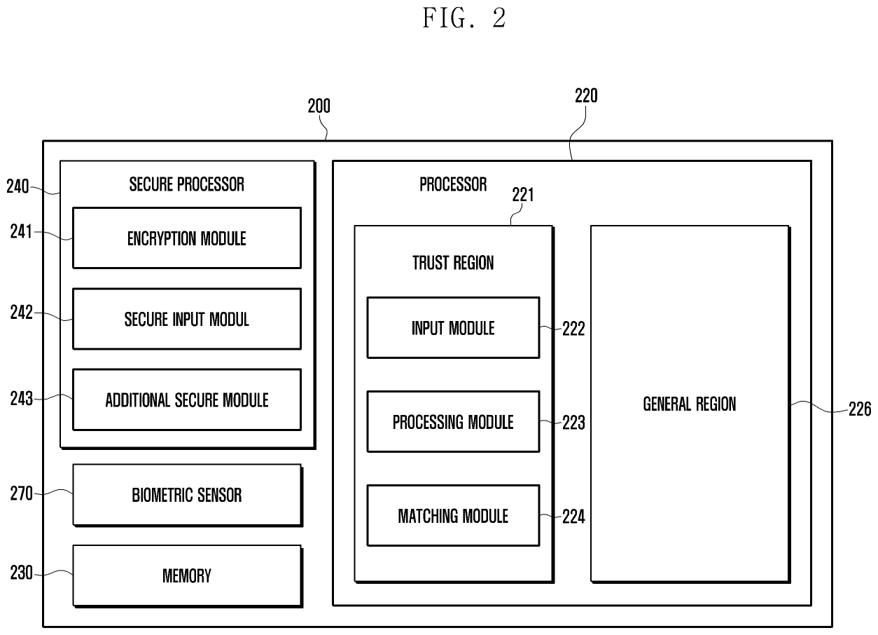

FIG. 2 is a block diagram of an electronic device according to various embodiments.

Referring to FIG. 2, an electronic device 200 (e.g., the electronic device 101 of FIG. 1) may include a processor 220 (e.g., the processor 120 of FIG. 1), a memory 230 (e.g., the memory 130 of FIG. 1), a secure processor 240, and/or a biometric sensor 270 (e.g., the sensor module 176 of FIG. 1). The component elements included in FIG. 2 may be part of configurations included in the electronic device 200, and the electronic device 200 may include various component elements in addition thereto, as illustrated in FIG. 1.

According to an embodiment, the biometric sensor 270 may be a sensor configured to acquire biometric data needed for biometric recognition and verification. For example, the biometric sensor 270 may include a fingerprint sensor, a retina and iris sensor, a camera, a microphone and/or other sensors capable of collecting biometric data. According to an embodiment, the biometric sensor 270 may detect user biometric information, for example, fingerprint information, iris information, vein information, voice information, and/or face information. For example, the fingerprint sensor may acquire a fingerprint of a person by using a feature detection technique that detects features from an optical fingerprint image, an ultrasonic image, and/or capacitive image. For example, an iris recognition sensor may acquire the structure of an iris of a person by using a video camera technique having a near-infrared ray lighting. For example, a face recognition sensor may acquire a high-resolution image of distinguishing facial features of a person by using a high-resolution video camera technique (e.g., a camera including a pixel resolution, a spatial resolution, a spectrum resolution, a temporal resolution, and/or a radioactive resolution). For example, a voice recognition sensor may include a microphone and/or an audio filter, and may acquire a voice pattern of a person. According to an embodiment, a combination of those sensors may be used in order to increase security. According to an embodiment, the biometric sensor 270 may include a transducer configured to produce an electric signal indicating biometric data.

The processor 220 according to an embodiment may include a trust region 221 and/or a general region 226. According to an embodiment, in the general region 226 (a rich execution environment (REE)), existing operating systems, for example, Linux, Android, or iOS, may operate, and a framework and/or an application that does not require separate security may operate according to control performed by the operating system. In the general region, it is difficult to restrict operation of vicious software, and thus there may be a risk when an operation that requires a high security level is performed. According to an embodiment, the trust region 221 (trust execution environment (TEE)) is an environment where applications that require security are executed, is a region separately isolated from a general region, and may restrict operation of an existing operating system and/or a framework, thereby preventing a security problem caused by vicious software. In the trust region 221, a system on chip (SoC) and various hardware resources may also be used.

An input module 222, a processing module 223, and/or a matching module 224 may be included in the trust region 221.

The input module 222 according to an embodiment may acquire biometric data from the biometric sensor 270 and may transmit the biometric data to the secure processor 240 via a secure channel. For example, a secure channel is an internal secure channel established between the trust region 221 of the processor 220 and the secure processor 240, and may be established by performing an authentication and key exchanging operation between the trust region 221 of the processor 220 and the secure processor 240. The processor 220 may transmit information to the secure processor 240 via a secure channel, so as to be safe from attacks from the outside.

The processing module 223 according to an embodiment may process encrypted biometric data acquired from the secure processor 240. For example, the processing module 223 may extract unique feature information of an individual based on the encrypted biometric data.

The matching module 224 according to an embodiment may determine whether feature information of encrypted biometric data processed by the processing module 223 matches feature information of biometric data acquired from the memory 230.

According to an embodiment, the secure processor 240 may be a configuration included in separate hardware distinguished from the processor 220. For example, the secure processor 240 may be a hardware secure chip (secure element IC) physically separated from the processor 220. For example, the secure processor 240 may be provided in the form of a separate CPU or co-processor. According to an embodiment, the secure processor 240 may include a secure region (not illustrated).

The secure processor 240 according to an embodiment may include an encryption module 241, a secure input module 242, and/or an additional secure module 243. For example, the encryption module 241, the secure input module 242, and/or the additional secure module 243 may be located in a secure region (not illustrated).

According to an embodiment, the encryption module 241 may encrypt and/or decrypt biometric data.

The encryption module 241 according to an embodiment may encrypt and/or decrypt, based on an encryption key, biometric data received from the processor 220 (e.g., the input module 222) via a secure channel. The encryption module 241 may transmit encrypted biometric data to the processor 220 (e.g., the processing module 223) via a secure channel.

The secure input module 242 according to an embodiment may directly acquire biometric data from the biometric sensor 270. The secure input module 242 may transmit acquired biometric data to the encryption module 241.

The additional secure module 243 according to an embodiment may determine whether the encryption module 241 of the secure processor 240 satisfies a condition for performing an operation of encrypting biometric data, and may control the encryption module 241.

For example, the additional secure module 243 may request input of information for additional security authentication before the encryption module 241 encrypts biometric data. For example, the additional secure module 243 may request input of at least one of an authentication pin, pattern, and/or password. Based on the fact that at least one of the input authentication pin, pattern, and/or password matches a designated authentication pint, pattern, and/or password, the additional secure module 243 may control the encryption module 241 so that the encryption module 241 encrypts acquired biometric data.

As another example, the additional secure module 243 may determine whether a predetermined time has elapsed from a time at which the matching module 224 of the processor 220 performs biometric authentication last. In response to determining that the designated time has not elapsed, the additional secure module 243 may control the encryption module 241 to perform encryption of biometric data.

As another example, the additional secure module 243 may determine whether a designated time has elapsed from a time at which biometric data is acquired from the biometric sensor 270 last. In response to determining that the designated time has not elapsed, the additional secure module 243 may control the encryption module 241 to perform encryption of the biometric data.

According to various embodiments, the general region 226, the trust region 221, and/or a secure region (not illustrated) are environments where applications are executed and which are classified based on a security level, and accessibility to each region may be determined based on a security level. The general region 226 has a lower security level than those of the trust region 221 and the secure region (not illustrated), and thus may be easily accessed by a general application. The security level of the trust region 221 is higher than the security level of the general region 226, and is lower than the security level of a secure region (not illustrated). The trust region 221 may be provided in the form of hardware or software included in the electronic device 200. The secure area (not illustrated) may have the highest security level among the above-described regions, and may be embodied as the secure processor 240 that is hardware separated from the general region 226 and the trust region 221, and may be included in the electronic device 200.

According to an embodiment, the memory 230 may store feature information of registered biometric data. For example, the feature information of registered biometric data is biometric data related to a user, and may be feature information extracted from data that the user registers in advance via the electronic device 200 for biometric authentication. According to an embodiment, the memory 230 may store a model that has been trained by using feature information of registered biometric data.

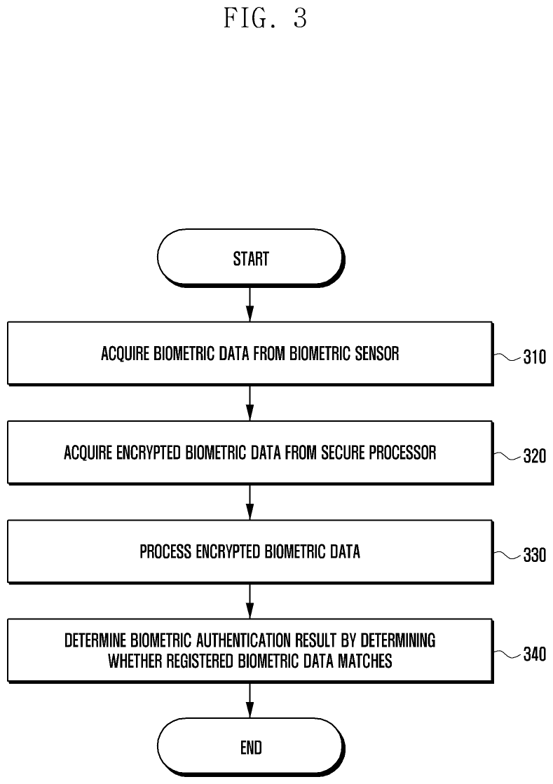

FIG. 3 is a flowchart illustrating a method of performing, by a processor (e.g., the processor 220 of FIG. 2), biometric authentication using biometric data encrypted by a secure processor according to various embodiments.

According to various embodiments, the processor 220 may acquire biometric data from a biometric sensor (e.g., the biometric sensor 270 of FIG. 2) in operation 310.

According to an embodiment, the processor 220 may acquire biometric data in a trust region (e.g., the trust region 221 of FIG. 2). The biometric data provided in the trust region 221 may be defended against access of an application of a general region (e.g., the general region 226 of FIG. 2).

According to an embodiment, the processor 220 may transmit the acquired biometric data to the secure processor 240.

According to an embodiment, an input module (e.g., the input module 222 of FIG. 2) in the trust region 221 of the processor 220 may transmit raw data related to the biometric data acquired from the biometric sensor 270 to a secure processor (e.g., the secure processor 240 of FIG. 2) via a secure channel. For example, a secure channel is an internal secure channel established between the trust region 221 of the processor 220 and the secure processor 240, and may be established by performing an authentication and key exchanging operation between the trust region 221 of the processor 220 and the secure processor 240. The processor 220 may transmit information to the secure processor 240 via a secure channel so as to be safe from attacks from the outside.

According to various embodiments, the processor 220 may acquire encrypted biometric data from the secure processor 240 in operation 320.

According to an embodiment, the secure processor 240 may encrypt biometric data.

According to an embodiment, the secure processor 240 may store a designated key. For example, the secure processor 240 may store at least one of an encryption key that fuses in hardware, a produced unique encryption key, an encryption key produced based on a physically unclonable function (PUF), or an encryption key injected from the outside during a manufacturing process. According to an embodiment, a produced unique encryption key may be a unique encryption key produced using a key derivation function (KDF) algorithm. According to an embodiment, a physically unclonable function (PUF) may be technique that produces an encryption key by using a difference in a microstructure of a semi-conductor produced in a process of manufacturing the same secure chip (e.g., the secure processor 240), and utilizes the same. The microstructure of a nanoscale semi-conductor is autonomously and randomly produced without a random number value provided from the outside, and thus may be utilized for production of an encryption key.

According to an embodiment, the encryption module 241 of the secure processor 240 may encrypt biometric data based on an encryption key.

According to an embodiment, the encryption module 241 of the secure processor 240 may encrypt biometric data according to a homomorphic encryption scheme that is an algorithm supporting an add operation and a multiplying operation without decrypting encrypted data. The homomorphic encryption scheme may be an encryption scheme in which a result (e.g., E(a+b)) acquired by performing a designated operation on unencrypted data is the same as a result (e.g., E(a)+E(b)) acquired by performing a designated operation on encrypted data. Biometric authentication may identify whether matching with biometric data registered finally is identified. In case that data is encrypted according to the homomorphic encryption scheme, a result of matching between data before encryption is the same as a result of matching between encrypted data, and thus raw biometric data is not exposed while an operation is performed with respect to encrypted data.

According to various embodiments, the processor 220 may acquire encrypted biometric data from the secure processor 240 via a secure channel. For example, the processor 220 may load, in the trust region 221, the encrypted biometric data, acquired from the secure processor 240.

According to various embodiments, the processor 220 may process the encrypted biometric data in operation 330.

According to an embodiment, the processor 220 may include a processing module (e.g., the processing module 223 of FIG. 2). The processing module 223 may process the encrypted biometric data acquired from the secure processor 240.

According to various embodiments, based on the encrypted biometric data, the processing module 223 of the processor 220 may extract unique feature information of an individual for biometric authentication.

According to an embodiment, the processing module 223 of the processor 220 may produce, based on the encrypted biometric data, feature information such as a biometric recognition template (biometric template) of an individual. For example, the feature information may be obtained in a predetermined format (or frame) in order to identify a degree of matching with registered biometric data. For example, the information format of the predetermined format may be in a template form. For example, in case of fingerprint recognition, feature information for fingerprint recognition may include feature points (minutiae) such as an end point of a line (ridge end) or a bifurcation point, a core point, or a delta point.

According to an embodiment, the processing module 223 of the processor 220 may extract feature information by inputting the encrypted biometric data to a trained model. For example, the processing module 223 may extract feature information of encrypted biometric data by using a deep learning algorithm having a deep neural network structure including multiple layers. Deep learning may be basically established in a deep neural network structure including multiple layers. A neural network used by the processing module 223 according to various embodiments of the disclosure may include a convolutional neural network, a deep neural network (DNN), a recurrent neural network (RNN), or a bidirectional recurrent deep neural network (BRDNN), but it is not limited thereto.

According to an embodiment, the processing module 223 may extract feature information by inputting the encrypted biometric data to a model that has been trained by using encrypted data. In case that an encryption key of encrypted data that the model has been trained is different from an encryption key of the encrypted biometric data input to the model, an abnormal result may be drawn.

According to an embodiment, the processing module 223 may extract feature information by inputting the encrypted biometric data to a model that has been trained by using raw data of biometric data. For example, the encrypted biometric data input to the model is homomorphic encrypted data, and thus the model that has been trained using the raw data of the biometric data may output feature information.

According to an embodiment, a trained model may be a model that has been trained based on encrypted biometric data input in the past and/or a history of raw data of biometric data.

According to various embodiments, the processor 220 may identify whether biometric data matches and may determine a biometric authentication result in operation 340.

According to an embodiment, from a memory (e.g., the memory 230 of FIG. 2), the processor 220 may acquire information related to registered biometric data including feature information of registered biometric data and/or a model that has been trained using feature information of registered biometric data.

According to an embodiment, the memory 230 may store the feature information of registered biometric data. For example, the feature information of registered biometric data is biometric data related to a user, and may be feature information extracted from data that a user registers in advance via the electronic device 200 for biometric authentication.

According to an embodiment, the feature information of registered biometric data stored in the memory 230 may be feature information extracted from registered biometric data that is encrypted by the encryption module 241 according to the homomorphic encryption.

According to an embodiment, the memory 230 may store a model that has been trained by using feature information of registered biometric data.

According to various embodiments, the processor 220 may compare registered biometric data and encrypted biometric data and may determine whether they match.

According to an embodiment, the processor 220 may include a matching module (e.g., the matching module 224 of FIG. 2). The matching module 224 may determine whether feature information of encrypted biometric data processed by the processing module 223 matches feature information of registered biometric data acquired from the memory 230.

According to an embodiment, the matching module 224 of the processor 220 may compare feature information that the processing module 223 obtains from encrypted biometric data with feature information of at least one piece of registered biometric data registered in advance and may obtain a matching value. The matching value may be a value indicating matching information between biometric data and registered biometric data. For example, a matching value may be obtained as a value indicating the number of pieces of feature information determined as corresponding to each other (or as being identical to each other) among feature information included in respective pieces of biometric data, during data matching. Alternatively, a matching value may be obtained based on statistic data or a probability function in consideration of a distance between pieces of feature information included in respective pieces of biometric data, directions, or similarity in disposition between pieces of feature information. According to an embodiment, the matching module 224 of the processor 220 may determine whether biometric authentication is successfully performed based on a matching value of feature information. For example, the matching module 224 of the processor 220 may determine that biometric authentication is successfully performed in response to the fact that a matching value exceeds a predetermined threshold value, and may determine that biometric authentication fails in response to the fact that a matching value is less than or equal to a configured threshold value.

According to an embodiment, the matching module 224 of the processor 220 may obtain a matching value by inputting biometric data to a trained model. For example, the matching module 224 of the processor 220 may extract a matching value of data by using a deep learning algorithm having a deep neural network structure including multiple layers.

According to an embodiment, the matching module 224 of the processor 220 may extract a matching value by inputting feature information of encrypted biometric data to a model that has been trained using feature information of encrypted registered biometric data. In case that an encryption key of registered biometric data that the model has been trained is different from an encryption key of the encrypted biometric data input to the model, an abnormal result may be drawn.

According to an embodiment, the matching module 224 of the processor 220 may output result information (e.g., a true-false type of signal) associated with whether authentication is successfully performed, and may transfer the same to a region where an event that requests biometric authentication occurs.

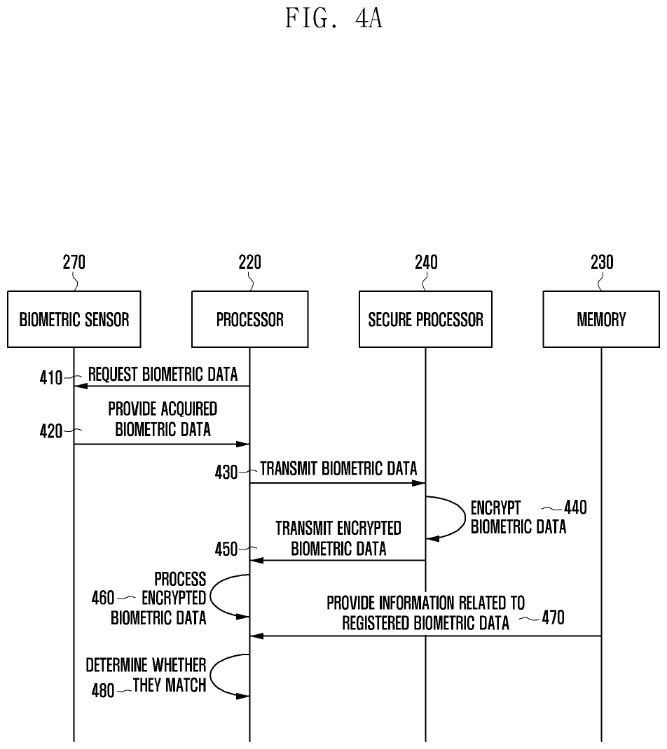

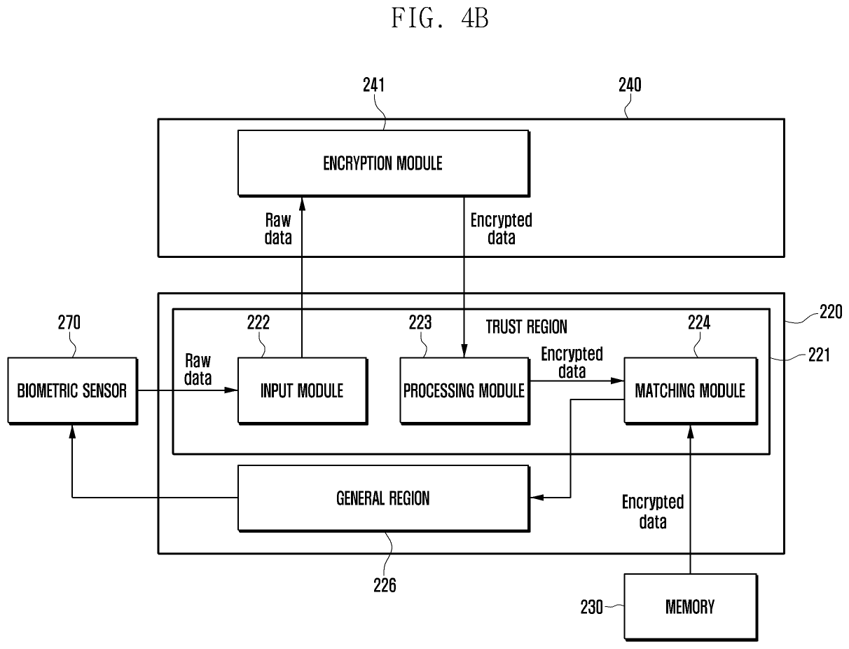

FIG. 4A is a diagram illustrating operation performed among a biometric sensor (e.g., the biometric sensor 270 of FIG. 2), a processor (e.g., the processor 220 of FIG. 2), a secure processor (e.g., the secure processor 240 of FIG. 2) and/or a memory (e.g., the memory 230 of FIG. 2) for biometric authentication according to various embodiments. According to various embodiments, the processor 220 may request biometric data from the biometric sensor 270 in operation 410.

According to an embodiment, an application included in a general region (e.g., the general region 226 of FIG. 2) of the processor 220 requests the biometric sensor 270 to acquire biometric data.

According to an embodiment, in response to occurrence of an event that requests biometric authentication, the processor 220 may request biometric data from the biometric sensor 270. For example, biometric authentication may be a process of recognizing measurable biometric data and an individual having biometric data. For example, the biometric data may include anatomical or physiological data such as a fingerprint, the characteristic of a palm (e.g., veins), a facial feature, DNA, a signature, a voice feature, a hand feature (e.g., a geometric structure), an iris structure, a retina feature, and/or scent.

According to an embodiment, an event for requesting biometric authentication may include an event for requesting biometric recognition in order to identify and verify the identity of an individual. For example, an event that requests biometric authentication may include various events that need security authentication, such as a request for unlocking (lock-off) of the electronic device 200, execution of an application that requests security authentication (e.g., a locked application), log-in to an account, accessing security information, an operation of an application related to financial trade (e.g., sending money via a bank application, paying for a purchased product), or an operation of an application related to telemedicine.

According to an embodiment, before requesting biometric data from the biometric sensor 270, the processor 220 may output an alarm for requesting a user to input biometric data. For example, the processor 220 may display, in a display of the electronic device 200, a biometric data request alarm via a pop-up window including text and/or an image.

According to an embodiment, the biometric sensor 270 may acquire biometric data for biometric recognition.

According to an embodiment, the biometric sensor 270 may recognize an operation of inputting biometric data by a user. In case that the operation of inputting security information by a user is recognized, the biometric sensor 270 may produce interruption (interrupt). For example, a fingerprint sensor among the biometric sensors 270 may recognize an operation in which a user touches a sensor with a finger, and may produce interruption corresponding thereto. An iris sensor among the biometric sensors 270 may recognize an iris when a user's eye approaches the sensor, and may produce interruption corresponding thereto. A vein sensor among the biometric sensors 270 may recognize the distribution of veins when a user's hand approaches the sensor, and may produce interruption corresponding thereto. In case that a user inputs a signal for inputting voice, a voice sensor among the biometric sensors 270 may produce interruption corresponding thereto. A face sensor among the biometric sensors 270 may recognize a facial contour including eyes, the nose, and/or the mouth when a user's face approaches the sensor, and may produce interruption corresponding thereto.

According to an embodiment, the processor 220 may recognize interruption that the biometric sensor 270 produces in the general region 226. For example, the biometric sensor 270 may transfer produced interruption to a security information recognition driver (not illustrated) located in the general region 226 of the processor 220. The security information recognition driver may transfer the received interruption to an input module (e.g., the input module 222 of FIG. 2) located in the trust region 221 of the processor 220.

According to various embodiments, the biometric sensor 270 may directly transfer interruption to the input module 222 located in the trust region 221 of the processor 220.

According to various embodiments, the biometric sensor 270 may provide acquired biometric data to the processor 220 in operation 420.

According to an embodiment, the biometric sensor 270 may provide biometric data to the trust region 221 of the processor 220. The biometric data provided in the trust region 221 may be protected from access of an application of the general region 226.

According to an embodiment, in response to recognizing interruption, the processor 220 may switch a region for operation to the trust region 221 so as to acquire, in the trust region 221, raw data related to the biometric data that the biometric sensor 270 acquires.

According to an embodiment, in response to received interruption, the input module 222 in the trust region 221 of the processor 220 may read raw data related to biometric data of a user from the biometric sensor 270. The input module 222 is located in the trust region 221, and thus may defend raw data related to biometric data of a user against a vicious external hacking tool from the initial stage of an input process.

According to various embodiments, the processor 220 may transmit the acquired biometric data to the secure processor 240 in operation 430.

According to an embodiment, the secure processor 240 may be a configuration included in separate hardware distinguished from the processor 220. For example, the secure processor 240 may be a hardware secure chip that is physically separated from the processor 220. For example, the secure processor 240 may be provided in the form of a separate CPU or co-processor.

According to an embodiment, the input module 222 in the trust region 221 of the processor 220 may transfer raw data related to biometric data to the secure processor 240 via a secure channel. For example, a secure channel is an internal secure channel established between the trust region 221 of the processor 220 and the secure processor 240, and may be established by performing an authentication and key exchanging operation between the trust region 221 of the processor 220 and the secure processor 240. The processor 220 may transmit information to the secure processor 240 via a secure channel so as to be safe from attacks from the outside.

According to various embodiments, the secure processor 240 may encrypt biometric data in operation 440.

According to an embodiment, the secure processor 240 may include an encryption module (e.g., the encryption module 241 of FIG. 2). The encryption module 241 may encrypt and/or decrypt biometric data.

According to an embodiment, the secure processor 240 may store a designated key. For example, the secure processor 240 may store at least one of an encryption key that fuses in hardware, a produced unique encryption key, an encryption key produced based on a physically unclonable function (PUF), or an encryption key injected from the outside during a manufacturing process. According to an embodiment, a produced unique encryption key may be a unique encryption key produced using a key derivation function (KDF) algorithm.

According to an embodiment, the encryption module 241 of the secure processor 240 may encrypt biometric data based on an encryption key.

According to an embodiment, the encryption module 241 of the secure processor 240 may encrypt biometric data according to a homomorphic encryption scheme that is an algorithm supporting an add operation and a multiplying operation without decrypting encrypted data.

According to an embodiment, the secure processor 240 may include an additional secure module (e.g., the additional secure module 243 of FIG. 2). The additional secure module 243 may determine whether the encryption module 241 of the secure processor 240 satisfies a condition for performing an operation of encrypting biometric data, and may control the encryption module 241.

According to various embodiments, the secure processor 240 may transmit, to the processor 220, the encrypted biometric data to the secure processor 240 in operation 450.

According to an embodiment, the secure processor 240 may transmit the encrypted biometric data to the processing module 223 of the processor 220 via a secure channel.

According to various embodiments, the processor 220 may process the encrypted biometric data in operation 460.

According to an embodiment, the processor 220 may include a processing module (e.g., the processing module 223 of FIG. 2). The processing module 223 may process encrypted biometric data acquired from the secure processor 240.

According to various embodiments, the processing module 223 of the processor 220 may extract, based on the encrypted biometric data, unique feature information of an individual.

According to an embodiment, the processing module 223 of the processor 220 may produce, based on the encrypted biometric data, feature information such as a biometric recognition template (biometric template). For example, the feature information may be obtained in a predetermined format (or frame) in order to identify a degree of matching with registered biometric data. For example, the information format of the predetermined format may be in a template form. For example, in case of fingerprint recognition, feature information for fingerprint recognition may include feature points (minutiae) such as an end point of a line (ridge end) or a bifurcation point, a core point, or a delta point.

According to an embodiment, the processing module 223 of the processor 220 may extract feature information by inputting the encrypted biometric data to a trained model. For example, the processing module 223 of the processor 220 may extract feature information of the encrypted biometric data by using a deep learning algorithm having a deep neural network structure including multiple layers.

According to an embodiment, the processing module 223 of the processor 220 may extract feature information by inputting encrypted biometric data to a model that has using learned encrypted data. In case that an encryption key of the encrypted data that the model has been trained is different from an encryption key of the encrypted biometric data input to the model, an abnormal result may be drawn.

According to an embodiment, the processing module 223 of the processor 220 may extract feature information by inputting the encrypted biometric data to a model that has been trained using raw data of biometric data. For example, the encrypted biometric data input to the model is homomorphic encrypted data, and thus the model that has been trained using the raw data of the biometric data may output feature information.

According to an embodiment, a trained model may be a model that has been trained based on encrypted biometric data input in the past and/or a history of raw data of biometric data.

According to various embodiments, in operation 470, the memory 230 may provide, to the processor 220, information including feature information of registered biometric data and/or a model that has been trained using feature information of registered biometric data.

According to an embodiment, the memory 230 may store the feature information of the registered biometric data. For example, the feature information of the registered biometric data is biometric data related to a user, and may be feature information extracted from data that a user registers in advance via the electronic device 200 for biometric authentication.

According to an embodiment, the feature information of the registered biometric data stored in the memory 230 may be feature information extracted from registered biometric data encrypted according to the homomorphic encryption by the encryption module 241.

According to an embodiment, the memory 230 may store a model that has been trained by using the feature information of the registered biometric data.

According to various embodiments, the processor 220 may compare the registered biometric data and the encrypted biometric data, and may determine whether they match in operation 480.

According to an embodiment, the processor 220 may include a matching module (e.g., the matching module 224 of FIG. 2). The matching module 224 may determine whether the feature information of the encrypted biometric data processed by the processing module 223 matches the feature information of the registered biometric data acquired from the memory 230.

According to an embodiment, the matching module 224 of the processor 220 may compare the feature information that the processing module 223 obtains from the encrypted biometric data with the feature information of at least one piece of registered biometric data registered in advance, and may obtain a matching value. The matching value may be a value indicating matching information between the biometric data and the registered biometric data. For example, the matching value may be obtained as a value indicating the number of pieces of feature information determined as corresponding to each other (or as being identical to each other) among pieces of feature information included in respective pieces of biometric data during data matching. Alternatively, the matching value may be obtained based on statistic data or a probability function in consideration of the distance between pieces of feature information included in biometric data, directions, or similarity in disposition between pieces of feature information. According to an embodiment, the matching module 224 of the processor 220 may determine whether biometric authentication is successfully performed based on a matching value of feature information. For example, the matching module 224 of the processor 220 may determine that biometric authentication is successfully performed in response to the fact that a matching value exceeds a predetermined threshold value, and may determine that biometric authentication fails in response to the fact that a matching value is less than or equal to a configured threshold value.

According to an embodiment, the matching module 224 of the processor 220 may obtain a matching value by inputting biometric data to a trained model. For example, the matching module 224 of the processor 220 may extract a matching value between data using a deep learning algorithm having a deep neural network structure including multiple layers.

According to an embodiment, the matching module 224 of the processor 220 may extract a matching value by inputting the feature information of the encrypted biometric data to a model that has been trained using the feature information of the encrypted registered biometric data. In case that an encryption key of the registered biometric data that the model has been trained is different from an encryption key of the encrypted biometric data input to the model, an abnormal result may be drawn.

According to an embodiment, the matching module 224 of the processor 220 may output result information (e.g., a true-false type of signal) associated with whether authentication is successfully performed, and may transfer the same to a region where an event that requests biometric authentication occurs.

FIG. 4B is a diagram illustrating the configuration of an electronic device (e.g., the electronic device 200 of FIG. 2) and a flow of data according to various embodiments.

The duplication of the description of FIG. 4A will be omitted in the description below.

The electronic device 200 according to various embodiments may include the biometric sensor 270 configured to acquire data needed for biometric recognition and verification, the processor 220, the secure processor 240 included in separate hardware distinguished from the processor 220, and/or the memory 230. According to an embodiment, the processor 220 may be divided into the general region 226 and the trust region 221. The processor 220 may include, in the trust region 221, the input module 222 that acquires biometric data, the processing module 223 that processes encrypted biometric data, and/or the matching module 224 that matches biometric data and registered biometric data. According to an embodiment, the secure processor 240 may include the encryption module 241 that encrypts biometric data.

According to an embodiment, an application included in the general region 226 of the processor 220 may request the biometric sensor 270 to acquire biometric data. According to an embodiment, the biometric sensor 270 may provide biometric data to the input module 222 in the trust region 221. The biometric data provided in the trust region 221 may be protected from access of an application of the general region.

According to an embodiment, the input module 222 may read raw data related to biometric data of a user from the biometric sensor 270. The input module 222 is located in the trust region 221, and thus may defend raw data related to biometric data of a user against a vicious external hacking tool from the initial stage of an input process.

According to an embodiment, the input module 222 may transmit the acquired biometric data (raw data) to the encryption module 241. According to an embodiment, the input module 222 may transfer raw data related to biometric data to the secure processor 240 via a secure channel. For example, a secure channel is an internal secure channel established between the trust region 221 of the processor 220 and the secure processor 240, and may be established by performing an authentication and key exchanging operation between the trust region 221 of the processor 220 and the secure processor 240.

According to an embodiment, the encryption module 241 may encrypt biometric data.

According to an embodiment, the secure processor 240 may store a designated key. For example, the secure processor 240 may store at least one of an encryption key that fuses in hardware, a produced unique encryption key, an encryption key produced based on a physically unclonable function (PUF), or an encryption key injected from the outside during a manufacturing process. According to an embodiment, a produced unique encryption key may be a unique encryption key produced using a key derivation function (KDF) algorithm.

According to an embodiment, the encryption module 241 may encrypt, based on an encryption key, biometric data according to a homomorphic encryption scheme.

According to an embodiment, the secure processor 240 may transmit encrypted biometric data to the processing module 223.

According to an embodiment, the processing module 223 may extract, based on encrypted biometric data acquired from the secure processor 240, unique feature information of an individual. For example, the processing module 223 may extract feature information via conversion into a biometric recognition template or by using a trained model.

According to an embodiment, the memory 230 may provide, to the matching module 224, information related to registered biometric data. For example, the memory 230 may provide, to the matching module 224, information including feature information of registered biometric data and/or a model that has been trained using feature information of registered biometric data.

According to an embodiment, the matching module 224 may determine whether feature information of encrypted biometric data processed by the processing module 223 matches feature information of registered biometric data. For example, the matching module 224 may obtain a matching value by comparing pieces of feature information included in biometric data or by inputting feature information to a trained model.

For example, the matching module 224 may determine that biometric authentication is successfully performed in response to the fact that a matching value exceeds a predetermined threshold value, and may determine that biometric authentication fails in response to the fact that a matching value is less than or equal to a configured threshold value.

According to an embodiment, the matching module 224 may transfer whether biometric authentication is successfully performed to an application that requests biometric authentication in the general region 226. The application in the general region 226 may determine whether to perform an additional operation in response to whether the biometric authentication is successfully performed.

As illustrated in FIG. 4B, after the encryption module 241 of the secure processor 240 encrypts biometric data, the remaining operations may be performed based on the encrypted data, and thus, although a processing operation and a matching operation are performed in the processor 220, raw data related to the biometric data may not be exposed.

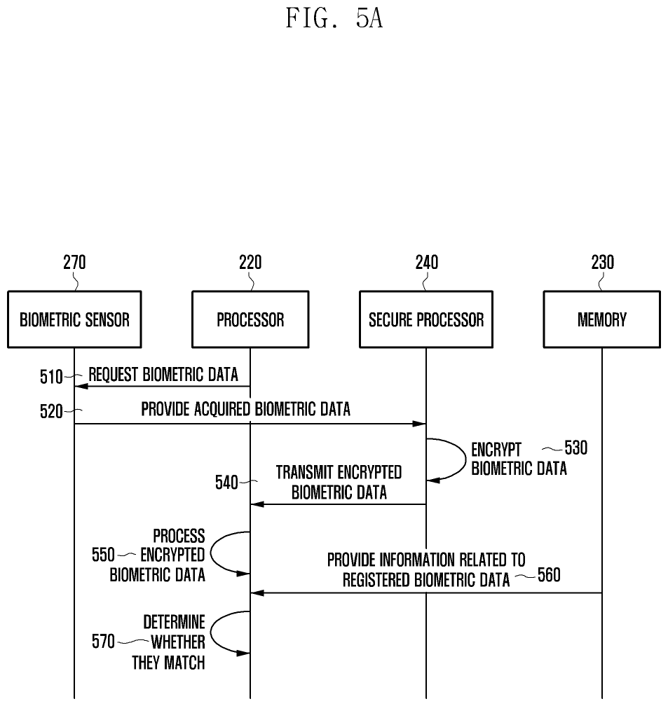

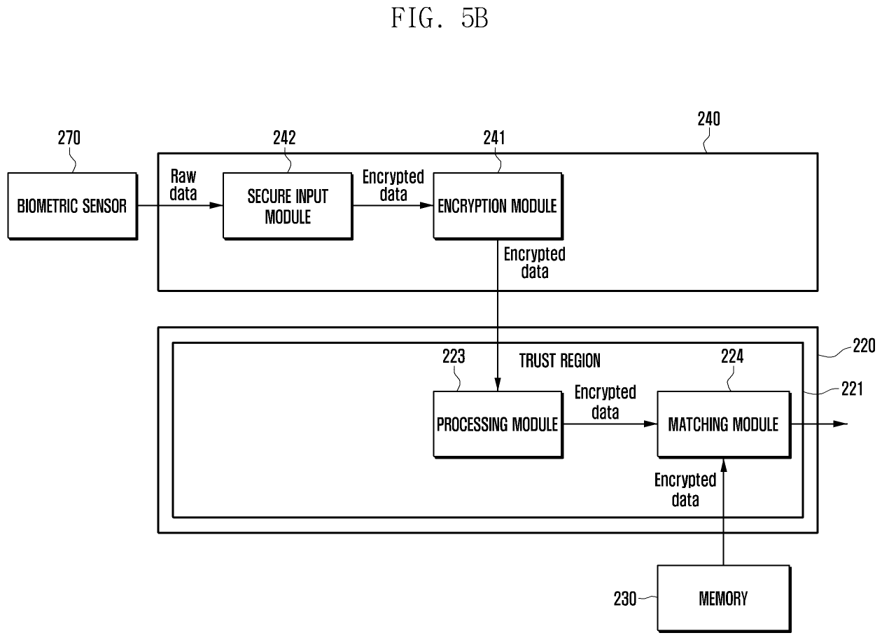

FIG. 5A is a diagram illustrating operation performed among a biometric sensor (e.g., the biometric sensor 270 of FIG. 2), a processor (e.g., the processor 220 of FIG. 2), a secure processor (e.g., the secure processor 240 of FIG. 2) and/or a memory (e.g., the memory 230 of FIG. 2) for biometric authentication according to various embodiments.

According to various embodiments, the processor 220 may request biometric data from the biometric sensor 270 in operation 510.

According to another embodiment, the processor 220 (e.g., a general region or a trust region) may control the secure processor 240 to request biometric data from the biometric sensor 270.

According to an embodiment, the processor 220 may request biometric data from the biometric sensor 270 in response to occurrence of an event that requests biometric authentication.

According to an embodiment, an event for requesting biometric authentication may include an event for requesting biometric recognition in order to identify and verify the identity of an individual.

According to an embodiment, before requesting biometric data from the biometric sensor 270, the processor 220 may output an alarm for requesting a user to input biometric data.

According to an embodiment, the biometric sensor 270 may acquire biometric data for biometric recognition.

The biometric sensor 270 may be a sensor configured to acquire data needed for biometric recognition and verification.

According to an embodiment, the biometric sensor 270 may recognize an operation of inputting biometric data by a user. In case that the operation of inputting security information by a user is recognized, the biometric sensor 270 may produce interruption (interrupt).

According to an embodiment, in case that interruption is produced in the biometric sensor 270, the processor 220 may transfer the produced interruption to the secure processor 240.

According to various embodiments, the biometric sensor 270 may provide acquired biometric data to the secure processor 220 in operation 520.

According to an embodiment, the secure processor 240 may be a configuration included in separate hardware distinguished from the processor 220. For example, the secure processor 240 may be a hardware secure chip that is physically separated from the processor 220. For example, the secure processor 240 may be provided in the form of a separate CPU or co-processor.

According to an embodiment, in response to received interruption, the secure input module 242 of the secure processor 240 may read raw data related to the biometric data of a user from the biometric sensor 270. For example, the secure processor 240 (e.g., the secure input module 242) may receive biometric data from the biometric sensor 270 by using a secure communication driver (not illustrated) for communication with the biometric sensor 270. For example, the secure communication driver (not illustrated) may include an SPI driver.

According to an embodiment, the secure input module 242 may transmit the acquired biometric data to the encryption module 241.

According to various embodiments, the secure processor 240 may encrypt the biometric data in operation 530.

According to an embodiment, the secure processor 240 may include the encryption module 241. The encryption module 241 may encrypt and/or decrypt biometric data.

According to an embodiment, the secure processor 240 may store a designated key. For example, the secure processor 240 may store at least one of an encryption key that fuses in hardware, a produced unique encryption key, an encryption key produced based on a physically unclonable function (PUF), or an encryption key injected from the outside during a manufacturing process. According to an embodiment, a produced unique encryption key may be a unique encryption key produced using a key derivation function (KDF) algorithm.

According to an embodiment, the encryption module 241 of the secure processor 240 may encrypt biometric data based on an encryption key.

According to an embodiment, the encryption module 241 of the secure processor 240 may encrypt biometric data according to a homomorphic encryption scheme that is an algorithm supporting an add operation and a multiplying operation without performing a decryption operation on encrypted data.

According to an embodiment, the secure processor 240 may include an additional secure module (e.g., the additional secure module 243 of FIG. 2). The additional secure module 243 may determine whether the encryption module 241 of the secure processor 240 satisfies a condition for performing an operation of encrypting biometric data, and may control the encryption module 241.

According to various embodiments, the secure processor 240 may transmit the encrypted biometric data to the processor 220 in operation 540.

According to an embodiment, the secure processor 240 may transmit the encrypted biometric data to the processing module 223 of the processor 220 via a secure channel.

According to various embodiments, the processor 220 may process the encrypted biometric data in operation 550.

According to an embodiment, the processor 220 may include a processing module (e.g., the processing module 223 of FIG. 2). The processing module 223 may process the encrypted biometric data acquired from the secure processor 240.

According to various embodiments, the processing module 223 of the processor 220 may extract unique feature information of an individual based on the encrypted biometric data.

According to an embodiment, the processing module 223 of the processor 220 may produce, based on the encrypted biometric data, feature information such as a biometric recognition template (biometric template).

According to an embodiment, the processing module 223 of the processor 220 may extract feature information by inputting the encrypted biometric data to a trained model. For example, the processing module 223 of the processor 220 may extract the feature information of the encrypted biometric data using a deep learning algorithm having a deep neural network structure including multiple layers.

According to an embodiment, the processing module 223 of the processor 220 may extract feature information by inputting the encrypted biometric data to a model that has been trained using encrypted data. In case that an encryption key of the encrypted data that the model has been trained is different from an encryption key of the encrypted biometric data input to the model, an abnormal result may be drawn.

According to an embodiment, the processing module 223 of the processor 220 may extract feature information by inputting the encrypted biometric data to a model that has been trained using raw data of biometric data. For example, the encrypted biometric data input to the model is homomorphic encrypted data, and thus the model that has been trained using the raw data of the biometric data may output feature information.

According to an embodiment, a trained model may be a model that has been trained based on encrypted biometric data input in the past and/or a history of raw data of biometric data.

According to various embodiments, the memory 230 may provide, to the processor 220, information related to registered biometric data in operation 560.

According to an embodiment, the memory 230 may provide, to the processor 220, information including feature information of registered biometric data and/or a model that has been trained feature information of registered biometric data.

According to an embodiment, the memory 230 may store the feature information of the registered biometric data. For example, the feature information of the registered biometric data may biometric data related to a user, and may be feature information extracted from data that a user registers in advance via the electronic device 200 for biometric authentication.

According to an embodiment, the feature information of the registered biometric data stored in the memory 230 may be the feature information extracted from the registered biometric data encrypted according to the homomorphic encryption by the encryption module 241.

According to an embodiment, the memory 230 may store a model that has been trained by using the feature information of the registered biometric data.

According to various embodiments, the processor 220 may identify whether the registered biometric data and the encrypted biometric data match by comparing them in operation 570.

According to an embodiment, the processor 220 may include a matching module (e.g., the matching module 224 of FIG. 2). The matching module 224 may determine whether the feature information of the encrypted biometric data processed by the processing module 223 matches the feature information of the registered biometric data acquired from the memory 230.

According to an embodiment, the matching module 224 of the processor 220 may compare the feature information that the processing module 223 obtains from the encrypted biometric data with the feature information of at least one piece of registered biometric data registered in advance, and may obtain a matching value. The matching value may be a value indicating matching information between the biometric data and the registered biometric data.

According to an embodiment, the matching module 224 of the processor 220 may acquire a matching value by inputting biometric data to a trained model. For example, the matching module 224 of the processor 220 may extract a matching value between pieces of data by using a deep learning algorithm having a deep neural network structure including multiple layers.

According to an embodiment, the matching module 224 of the processor 220 may extract a matching value by inputting the feature information of the encrypted biometric data to a model that has been trained using the feature information of encrypted registered biometric data. In case that an encryption key of the registered biometric data that the model has been trained is different from an encryption key of the encrypted biometric data input to the model, an abnormal result may be drawn.

According to an embodiment, the matching module 224 of the processor 220 may output result information (e.g., a true-false type of signal) associated with whether authentication is successfully performed, and may transfer the same to a region where an event that requests biometric authentication occurs.

FIG. 5B is a diagram illustrating the configuration of an electronic device (e.g., the electronic device 200 of FIG. 2) and a flow of data according to various embodiments.

The duplication of the description of FIG. 5A will be omitted in the description below.

The electronic device 200 according to various embodiments may include the biometric sensor 270 configured to acquire data needed for biometric recognition and verification, the processor 220, and the secure processor 240 included in separate hardware distinguished from the processor 220, and/or the memory 230. According to an embodiment, the processor 220 may include, in the trust region (TEE) 221, the processing module 223 to process encrypted biometric data and/or the matching module 224 to match biometric data and registered biometric data. According to an embodiment, the secure processor 240 may include the secure input module 242 to acquire biometric data and/or the encryption module 241 to encrypt biometric data.

According to an embodiment, the secure processor 240 may be a configuration included in separate hardware distinguished from the processor 220. For example, the secure processor 240 may be a hardware secure chip that is physically separated from the processor 220. For example, the secure processor 240 may be provided in the form of a separate CPU or co-processor.

According to an embodiment, the biometric sensor 270 may provide biometric data (raw data) to the secure input module 242 of the secure processor 240. According to an embodiment, biometric data provided to the secure processor 240 may be protected from access of an application of a general region.

According to an embodiment, the secure input module 242 may directly read raw data related to biometric data of a user from the biometric sensor 270. The secure input module 242 is located in the secure processor 240, and thus may defend raw data related to biometric data of a user against a vicious external hacking tool from the initial stage of an input process.

According to an embodiment, the secure input module 242 may transmit the acquired biometric data (raw data) to the encryption module 241.

According to an embodiment, the encryption module 241 may encrypt biometric data.

According to an embodiment, the secure processor 240 may store a designated key. For example, the secure processor 240 may store at least one of an encryption key that fuses in hardware, a produced unique encryption key, an encryption key produced based on a physically unclonable function (PUF), or an encryption key injected from the outside during a manufacturing process. According to an embodiment, a produced unique encryption key may be a unique encryption key produced using a key derivation function (KDF) algorithm.

According to an embodiment, the encryption module 241 may encrypt, based on an encryption key, biometric data according to a homomorphic encryption scheme.

According to an embodiment, the secure processor 240 may transmit encrypted biometric data to the processing module 223.

According to an embodiment, the processing module 223 may extract, based on encrypted biometric data acquired from the secure processor 240, unique feature information of an individual. For example, the processing module 223 may extract feature information via conversion into a biometric recognition template or by using a trained model.

According to an embodiment, the memory 230 may provide, to the matching module 224, information related to registered biometric data. For example, the memory 230 may provide, to the matching module 224, information including feature information of registered biometric data and/or a model that has been trained using feature information of registered biometric data.

According to an embodiment, the matching module 224 may determine whether feature information of encrypted biometric data processed by the processing module 223 matches feature information of registered biometric data. For example, the matching module 224 may obtain a matching value by comparing pieces of feature information included in biometric data or by inputting feature information to a trained model.

For example, the matching module 224 may determine that biometric authentication is successfully performed in response to the fact that a matching value exceeds a predetermined threshold value, and may determine that biometric authentication fails in response to the fact that a matching value is less than or equal to a configured threshold value.

As illustrated in FIG. 5B, after the biometric sensor 270 directly provides biometric data to the secure processor 240, the remaining operations for biometric authentication may be performed based on encrypted data, and thus, although a processing operation and a matching operation are performed in the processor 220, raw data related to the biometric data may not be exposed.

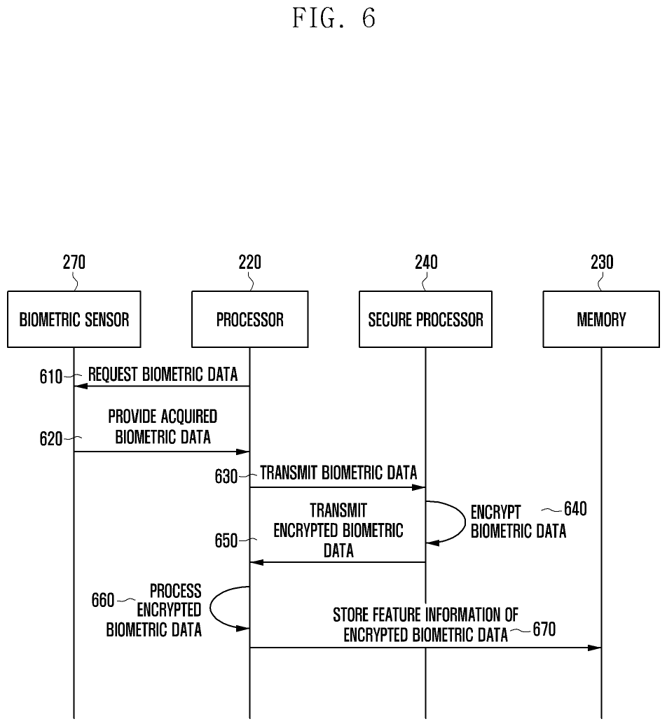

FIG. 6 is a diagram illustrating operation performed among a biometric sensor (e.g., the biometric sensor 270 of FIG. 2), a processor (e.g., the processor 220 of FIG. 2), a secure processor (e.g., the secure processor 240 of FIG. 2) and/or a memory (e.g., the memory 230 of FIG. 2) for biometric authentication.

According to various embodiments, the processor 220 may request biometric data from the biometric sensor 270 in operation 610.

According to an embodiment, an application included in a general region (e.g., the general region 226 of FIG. 2) of the processor 220 requests the biometric sensor 270 to acquire biometric data.

According to an embodiment, the processor 220 may request biometric data from the biometric sensor 270 in response to occurrence of an event that requests registration of biometric authentication.

For example, biometric authentication may be a process of recognizing measurable biometric data and an individual that has biometric data.

According to an embodiment, before requesting biometric data from the biometric sensor 270, the processor 220 may output an alarm for requesting a user to input biometric data.

According to an embodiment, the biometric sensor 270 may acquire biometric data for biometric recognition.

According to an embodiment, the biometric sensor 270 may recognize an operation of inputting biometric data by a user. In case that the operation of inputting security information by a user is recognized, the biometric sensor 270 may produce interruption (interrupt).

According to an embodiment, the processor 220 may recognize interruption that the biometric sensor 270 produces in the general region 226. For example, the biometric sensor 270 may transfer produced interruption to a security information recognition driver (not illustrated) located in the general region 226 of the processor 220. The security information recognition driver may transfer the received interruption to an input module (e.g., the input module 222 of FIG. 2) located in the trust region 221 of the processor 220.

According to another embodiment, the biometric sensor 270 may directly transfer interruption to the input module 222 located in the trust region 221 of the processor 220.

According to various embodiments, the biometric sensor 270 may provide acquired biometric data to the processor 220 in operation 620.

According to an embodiment, the biometric sensor 270 may provide biometric data to the trust region 221 of the processor 220. The biometric data provided in the trust region 221 may be protected from access of an application of the general region 226.

According to an embodiment, in response to recognizing interruption, the processor 220 may switch a region for operation to the trust region 221 so as to acquire raw data related to the biometric data that the biometric sensor 270 acquires.

According to an embodiment, in response to received interruption, the input module 222 in the trust region 221 of the processor 220 may read raw data related to the biometric data of a user from the biometric sensor 270. The input module 222 is located in the trust region 221, and thus may protect raw data related to biometric data of a user from a vicious external hacking tool at the initial stage of an input process.

According to another embodiment, the biometric sensor 270 may directly provide biometric data to the secure processor 240. For example, the secure processor 240 may be a configuration included in separate hardware distinguished from the processor 220. For example, the secure processor 240 may be a hardware secure chip that is physically separated from the processor 220. For example, the secure processor 240 may be provided in the form of a separate CPU or co-processor.

For example, in case that the secure processor 240 includes the secure input module 242, the biometric sensor 270 may directly transfer produced interruption to the secure input module 242 of the secure processor 240. In response to received interruption, the secure input module 242 of the secure processor 240 may read raw data related to the biometric data of a user from the biometric sensor 270.

According to various embodiments, the processor 220 may transmit the acquired biometric data to the secure processor 240 in operation 630.

According to an embodiment, the input module 222 in the trust region 221 of the processor 220 may transfer raw data related to biometric data to the secure processor 240 via a secure channel. For example, a secure channel is an internal secure channel established between the trust region 221 of the processor 220 and the secure processor 240, and may be established by performing an authentication and key exchanging operation between the trust region 221 of the processor 220 and the secure processor 240. The processor 220 may transmit information to the secure processor 240 via a secure channel so as to be safe from attacks from the outside.

According to an embodiment, the secure processor 240 may include an additional secure module (e.g., the additional secure module 243 of FIG. 2). The additional secure module 243 may determine whether the encryption module 241 of the secure processor 240 satisfies a condition for performing an operation of encrypting biometric data, and may control the encryption module 241.

According to various embodiments, the secure processor 240 may encrypt the biometric data in operation 640.

According to an embodiment, the secure processor 240 may include the encryption module 241. The encryption module 241 may encrypt and/or decrypt biometric data.

According to an embodiment, the secure processor 240 may store a designated key. For example, the secure processor 240 may store at least one of an encryption key that fuses in hardware, a produced unique encryption key, an encryption key produced based on a physically unclonable function (PUF), or an encryption key injected from the outside during a manufacturing process. According to an embodiment, a produced unique encryption key may be a unique encryption key produced using a key derivation function (KDF) algorithm.

According to an embodiment, the encryption module 241 of the secure processor 240 may encrypt biometric data based on an encryption key.

According to an embodiment, the encryption module 241 of the secure processor 240 may encrypt the biometric data according to a homomorphic encryption scheme that is an algorithm supporting an add operation and a multiplying operation without performing a decryption operation on encrypted data.

According to various embodiments, the secure processor 240 may transmit the encrypted biometric data to the processor 220 in operation 650.

According to an embodiment, the secure processor 240 may transmit the encrypted biometric data to the processing module 223 of the processor 220 via a secure channel.

According to various embodiments, the processor 220 may process the encrypted biometric data in operation 660.

According to an embodiment, the processor 220 may include a processing module (e.g., the processing module 223 of FIG. 2). The processing module 223 may process the encrypted biometric data acquired from the secure processor 240.

According to various embodiments, the processing module 223 of the processor 220 may extract unique feature information of an individual based on the encrypted biometric data.

According to an embodiment, the processing module 223 of the processor 220 may produce, based on the encrypted biometric data, feature information such as a biometric recognition template (biometric template).

According to an embodiment, the processing module 223 of the processor 220 may extract feature information by inputting the encrypted biometric data to a trained model. For example, the processing module 223 may extract feature information of the encrypted biometric data using a deep learning algorithm having a deep neural network structure including multiple layers.

According to an embodiment, the processing module 223 of the processor 220 may extract feature information by inputting the encrypted biometric data to a model that has been trained using encrypted data. In case that an encryption key of the encrypted data that the model has been trained is different from an encryption key of the encrypted biometric data input to the model, an abnormal result may be drawn.

According to an embodiment, the processing module 223 of the processor 220 may extract feature information by inputting the encrypted biometric data to a model that has been trained using raw data of biometric data. For example, the encrypted biometric data input to the model is homomorphic encrypted data, and thus the model that has been trained using the raw data of the biometric data may output feature information.

According to an embodiment, a trained model may be a model that has been trained based on encrypted biometric data input in the past and/or a history of raw data of biometric data.

According to various embodiments, the processor 220 may store, in the memory 230, information related to the encrypted biometric data in operation 670.

According to an embodiment, the processor 220 may store the feature information of the encrypted biometric data in the memory 230.

According to various embodiments, the processor 220 may repeatedly perform operations 610 to 660 before performing operation 670, and may determine whether biometric data is accurate by comparing pieces of information related to the acquired biometric data.

According to an embodiment, the processor 220 may include a matching module (e.g., the matching module 224 of FIG. 2). The matching module 224 of the processor 220 may determine whether pieces of feature information of a plurality of pieces of encrypted biometric data processed in the processing module 223 match.

According to an embodiment, the matching module 224 of the processor 220 may obtain a matching value by comparing pieces of feature information of a plurality of pieces of encrypted biometric data processed in the processing module 223. The matching value may be a value indicating matching information among pieces of biometric data.

According to an embodiment, the matching module 224 of the processor 220 may determine whether accurate biometric data is acquired based on a matching value of a plurality of pieces of feature information. For example, the matching module 224 may determine, based on the fact that a matching value exceeds a configured threshold value, that accurate biometric data is acquired, and may determine, based on the fact that a matching value is less than or equal to the configured threshold value, that the acquired biometric data is inaccurate.

According to an embodiment, based on determining that accurate biometric data is acquired, the matching module 224 of the processor 220 may store information related to the encrypted biometric data in the memory 230 in operation 670. For example, the matching module 224 of the processor 220 may store average data of a plurality of pieces of data in the memory 230, may store any one piece of data among a plurality of pieces of data in the memory 230, or may store all of a plurality of pieces of data in the memory 230.

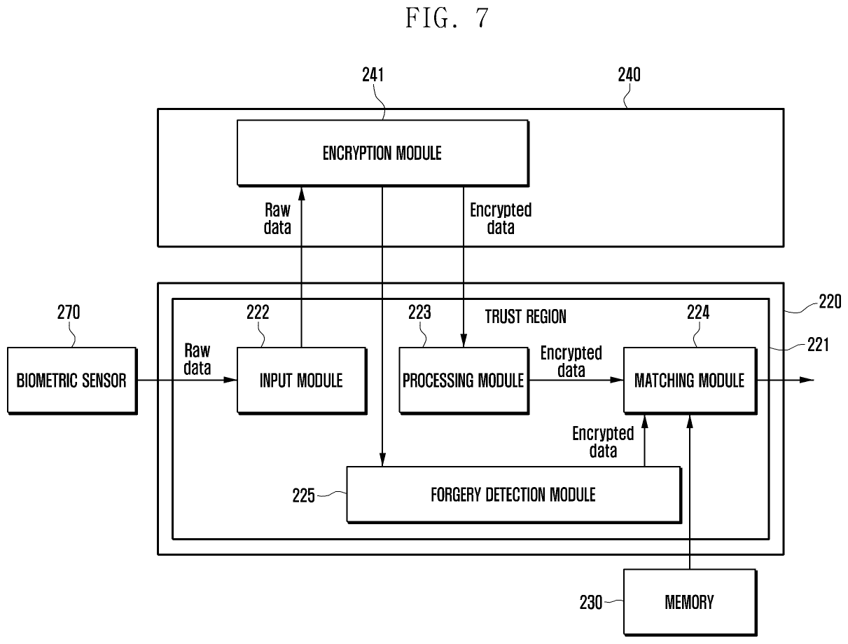

FIG. 7 is a diagram illustrating the configuration of an electronic device (e.g., the electronic device 200 of FIG. 2) and a flow of data according to various embodiments.

The duplication of the description of FIG. 4A will be omitted in the description below.

The electronic device 200 according to various embodiments may include the biometric sensor 270 configured to acquire data needed for biometric recognition and verification, the processor 220, and the secure processor 240 included in separate hardware distinguished from the processor 220, and/or the memory 230. According to an embodiment, the processor 220 may include, in the trust region (TEE) 221, the input module 222 to acquire biometric data, the processing module 223 to process encrypted biometric data, the matching module 224 to match biometric data and registered biometric data, and/or a forgery detection module 225. According to an embodiment, the secure processor 240 may include the encryption module 241 that encrypts biometric data.

The forgery detection module 225 according to various embodiments may be included in the processing module 223, may be included in the matching module 224, or may be a separate module in the trust region 221 of the processor 220.

According to an embodiment, the forgery detection module 225 may extract a forgery detection result by inputting, to a trained model, encrypted biometric data acquired from the encryption module 241 and feature information of the encrypted biometric data acquired from the processing module 223. For example, the forgery detection module 225 may extract feature information of encrypted biometric data by using a deep learning algorithm having a deep neural network structure including multiple layers. Deep learning may be basically established in a deep neural network structure including multiple layers. A neural network used by the forgery detection module 225 according to various embodiments of the disclosure may include a convolutional neural network, a deep neural network (DNN), a recurrent neural network (RNN), or a bidirectional recurrent deep neural network (BRDNN), but it is not limited thereto.

According to an embodiment, the forgery detection module 225 may extract a forgery detection result by inputting encrypted biometric data and feature information of encrypted biometric data to a model that has been trained using encrypted data. In case that an encryption key of the encrypted data that the model has been trained is different from an encryption key of the encrypted biometric data input to the model, an abnormal result may be drawn.

According to an embodiment, the forgery detection module 225 may extract a forgery detection result by inputting encrypted biometric data and feature information of encrypted biometric data to a model that has been trained using raw data of biometric data. For example, the encrypted biometric data input to the model is homomorphic encrypted data, and thus the model that has been trained using the raw data of the biometric data may output a forgery detection result.

According to an embodiment, a trained model may be a model that has been trained based on encrypted biometric data input in the past and/or a history of raw data of biometric data.

The electronic device 200 according to various embodiments of the disclosure may include: the biometric sensor 270 to acquire biometric data; the processor 220 including the general region 226 and the trust region 221 that is distinguished from the general region and that is configured to execute a trust application requiring a security level higher than or equal to a designated security level; the memory 230 configured to store encryption information (encryption data) related to registered biometric data; and the secure processor 240 physically separated from the processor 220, and the secure processor 240 is configured to encrypt the biometric data that the sensor acquires, and the processor 220 is configured to load (loading), in the trust region 221, the encrypted biometric data acquired from the secure processor 240, to extract feature information for biometric authentication from the encrypted biometric data, to compare the feature information and the encryption information acquired from the memory 230, and to perform the biometric authentication based on a result of the comparison.

In the electronic device 200 according to various embodiments of the disclosure, the secure processor 240 may store a designated key, and may encrypt, based on the designated key, the biometric data according to a homomorphic encryption scheme.

In the electronic device 200 according to various embodiments of the disclosure, the processor 220 may be configured to extract the feature information by inputting the encrypted biometric data to a model that has been trained by using encrypted data.

In the electronic device 200 according to various embodiments of the disclosure, the processor 220 may be configured to extract the feature information by inputting the encrypted biometric data to a model that has been trained by using biometric data.

In the electronic device 200 according to various embodiments of the disclosure, the encryption information may include feature information of the registered biometric data, and the processor 220 may obtain a matching value by comparing the feature information for the biometric authentication extracted from the encrypted biometric data and the feature information of the registered biometric data acquired from the memory 230, and may determine, based on a result of comparison between the matching value and a designated value, whether the biometric authentication is successfully performed.

In the electronic device 200 according to various embodiments of the disclosure, the memory 230 may store a model that has been trained by using the registered biometric data, and the processor 220 may acquire a matching value by inputting the feature information for the biometric authentication extracted from the encrypted biometric data to the model that has been trained by using the registered biometric data acquired from the memory 230, and may determine, based on a result of comparison between the matching value and a designated value, whether the biometric authentication is successfully performed.

In the electronic device 200 according to various embodiments of the disclosure, the secure processor 240 may request input of information for additional security authentication, and, in response to that the input information is identical to designated information, may encrypt the biometric data.

In the electronic device 200 according to various embodiments of the disclosure, the secure processor 240 may determine whether a designated time has elapsed from a time at which the processor 220 performs biometric authentication last, and, in response to determining that the designated time has not elapsed, may encrypt the biometric data.

The electronic device 200 according to various embodiments of the disclosure may further include a secure channel established between the trust region 221 of the processor 220 and the secure processor 240, and the processor 220 may acquire raw data related to the biometric data from the biometric sensor 270 in the trust region 221, and may transmit the acquired raw data related to the biometric data to the secure processor 240 via the secure channel.

The electronic device 200 according to various embodiments of the disclosure may further include a secure channel established between the biometric sensor 270 and the secure processor 240, and the secure processor 240 may acquire raw data related to the biometric data via the secure channel from the biometric sensor 270 and may encrypt the acquired raw data related to the biometric data.

An operation method of the electronic device 200 according to various embodiments of the disclosure may include: acquiring biometric data by a biometric sensor 270; encrypting the biometric data by the secure processor 240; acquiring the encrypted biometric data by the processor 220; loading, by the processor 220, the encrypted biometric data in the trust region 221 where a trust application requiring a security level higher than or equal to a designated security level is executed; extracting, by the processor 220, feature information for biometric authentication from the encrypted biometric data; comparing, by the processor 220, the feature information and encryption information (encryption data) related to registered biometric data acquired from the memory 230; and performing, by the processor 220, the biometric authentication based on a result of the comparison.

In the operation method of the electronic device 200 according to various embodiments of the disclosure, encrypting the biometric data may include: an operation in which the secure processor 240 encrypts, based on a designated key, the biometric data according to a homomorphic encryption scheme by the secure processor.

In the operation method of the electronic device 200 according to various embodiments of the disclosure, extracting the feature information may include: an operation in which the processor 220 extracts the feature information by inputting the encrypted biometric data to a model that has been trained by using encrypted data.

In the operation method of the electronic device 200 according to various embodiments of the disclosure, extracting the feature information may include an operation in which the processor 220 extracts feature information by inputting the encrypted biometric data to a model that has been trained by using biometric data.

In the operation method of the electronic device 200 according to various embodiments of the disclosure, the encryption information may include feature information of the registered biometric data, and the operation method may further include: obtaining, by the processor 220, a matching value by comparing the feature information for the biometric authentication extracted from the encrypted biometric data and the feature information of the registered biometric data acquired from the memory 230, and determining, by the processor 220, whether the biometric authentication is successfully performed based on a result of comparison between the matching value and a designated value.

The operation method of the electronic device 200 according to various embodiments of the disclosure may further include: acquiring, by the processor 220, a matching value by inputting the feature information for biometric authentication extracted from the encrypted biometric data to the model that has been trained by using registered biometric data acquired from the memory 230, and determining, by the processor 220, based on a result of comparison between the matching value and a designated value, whether the biometric authentication is successfully performed.

The operation method of the electronic device 200 according to various embodiments of the disclosure may further include: requesting, by the secure processor 240, input of information for additional security authentication, and encrypting, by the secure processor 240, the biometric data in response to that the input information is identical to designated information.

The operation method of the electronic device 200 according to various embodiments of the disclosure may further include: determining, by the secure processor 240, whether a designated time has elapsed from the time at which the secure processor 240 performs biometric authentication last, and encrypting, by the secure processor 240, the biometric data in response to determining that the designated time has not elapsed.

The operation method of the electronic device 200 according to various embodiments of the disclosure may further include: acquiring, by the processor 220, raw data related to the biometric data from the biometric sensor 270 in the trust region 221, and transmitting, by the processor 220, the raw data related to the biometric data to the secure processor 240 via a secure channel established between the trust region 221 of the processor 220 and the secure processor 240.

The operation method of the electronic device 200 according to various embodiments of the disclosure may further include: acquiring from the biometric sensor 270, by the secure processor 240, raw data related to the biometric data via a secure channel established between the biometric sensor 270 and the secure processor 240, and encrypting the acquired raw data related to the biometric data.

Various embodiments of the disclosure and the terms used therein are not to limit the technical features mentioned in the disclosure to predetermined embodiments, and should be construed as including various modifications, equivalents, or substitutes of the corresponding embodiment.

Identical or like reference numerals in the drawings denote identical or like component elements. A singular form of a noun corresponding to an item may include a single item or a plurality of items unless otherwise indicated in context.

In the disclosure, each of the phrases, such as “A or B”, “at least one of A and B”, “at least one of A or B”, “A, B, or C”, “at least one of A, B, and C”, and “at least one of B or C”, may include one of the items mentioned in the corresponding phrase among the phrases or a possible combination thereof. The term such as “1^{st}”, “2^{nd}” or a “first” or “second”, is merely used to distinguish a corresponding component element from another corresponding component element, and do not limit the corresponding components from another perspective (e.g., importance or an order). In case that it is mentioned that one (e.g., a first) component element is “coupled” or “connected” to another (e.g., a second) component element, together with a term “functionally” or “communicatively”, this means that the one component element is capable of being connected to another component element directly (e.g., in a wired manner), in a wireless manner, or via a third component element.

Embodiments of the disclosure provided in the specifications and drawings merely are certain examples to easily describe the technology associated with embodiments of the disclosure and to help understanding of the embodiments of the disclosure, but may not limit the scope of the embodiments of the disclosure. Therefore, it should be construed that the scope of the various embodiments of the disclosure may include all modifications or modified forms drawn based on the technical idea of the various embodiments of the disclosure in addition to the embodiments disclosed herein.

1. An electronic device comprising:
a biometric sensor configured to acquire biometric data;
a processor including a general region and a trust region that is distinguished from the general region and that is configured to execute a trust application requiring a security level higher than or equal to a designated security level;
a memory configured to store encryption information related to registered biometric data; and
a secure processor physically separated from the processor,
wherein the secure processor is configured to encrypt the biometric data that the sensor acquires, and
wherein the processor is configured to:
load, in the trust region, the encrypted biometric data acquired from the secure processor;
extract feature information for biometric authentication from the encrypted biometric data;
compare the feature information and the encryption information acquired from the memory; and
perform the biometric authentication based on a result of the comparison.

2. The electronic device of claim 1, wherein the secure processor is configured to:
store a designated key; and
encrypt, based on the designated key, the biometric data according to a homomorphic encryption scheme.

3. The electronic device of claim 1, wherein the processor is configured to extract the feature information by inputting the encrypted biometric data to a model that is trained using encrypted data.

4. The electronic device of claim 1, wherein the processor is configured to extract the feature information by inputting the encrypted biometric data to a model that is trained using biometric data.

5. The electronic device of claim 1, wherein the encryption information comprises feature information of the registered biometric data, and
wherein the processor is configured to:
obtain a matching value by comparing the feature information for the biometric authentication extracted from the encrypted biometric data and the feature information of the registered biometric data acquired from the memory; and
determine, based on a result of comparison between the matching value and a designated value, whether the biometric authentication is successfully performed.

6. The electronic device of claim 1, wherein the memory is configured to store a model that is trained using the registered biometric data; and
wherein the processor is configured to:
acquire a matching value by inputting the feature information for the biometric authentication extracted from the encrypted biometric data to the model that is trained using the registered biometric data acquired from the memory; and
determine, based on a result of comparison between the matching value and a designated value, whether the biometric authentication is successfully performed.

7. The electronic device of claim 1, wherein the secure processor is configured to:
request input of information for additional security authentication; and
in response to that the input information is identical to designated information, encrypt the biometric data.

8. The electronic device of claim 1, wherein the secure processor is configured to:
determine whether a designated time has elapsed from a time at which the processor performs biometric authentication last; and
in response to determining that the designated time has not elapsed, encrypt the biometric data.

9. The electronic device of claim 1, further comprising a secure channel established between the trust region of the processor and the secure processor,
wherein the processor is configured to:
acquire raw data related to the biometric data from the biometric sensor in the trust region; and
transmit the acquired raw data related to the biometric data to the secure processor via the secure channel.

10. The electronic device of claim 1, further comprising a secure channel established between the biometric sensor and the secure processor,
wherein the secure processor is configured to:
acquire raw data related to the biometric data from the biometric sensor via the secure channel; and
encrypt the acquired raw data related to the biometric data.

11. An operation method of an electronic device, the operation method comprising:
acquiring biometric data by a biometric sensor;
encrypting the biometric data by a secure processor;
acquiring the encrypted biometric data by a processor;
loading, by the processor, the encrypted biometric data in a trust region where a trust application requiring a security level higher than or equal to a designated security level is executed;
extracting, by the processor, feature information for biometric authentication from the encrypted biometric data;
comparing, by the processor, the feature information and encryption information related to registered biometric data acquired from the memory; and
performing, by the processor, the biometric authentication based on a result of the comparison.

12. The operation method of claim 11, wherein encrypting the biometric data comprises encrypting, based on a designated key, the biometric data according to a homomorphic encryption scheme by the secure processor.

13. The operation method of claim 11, wherein extracting, by the processor, the feature information comprises extracting, by the processor, the feature information by inputting the encrypted biometric data to a model that is trained using encrypted data.

14. The operation method of claim 11, wherein extracting, by the processor, the feature information comprises extracting, by the processor, the feature information by inputting the encrypted biometric data to a model that is trained using biometric data.

15. The operation method of claim 11, wherein the encryption information comprises feature information of the registered biometric data, and
wherein the operation method further comprises:
obtaining, by the processor, a matching value by comparing the feature information for the biometric authentication extracted from the encrypted biometric data and the feature information of the registered biometric data acquired from the memory; and
determining, by the processor, whether the biometric authentication is successfully performed based on a result of comparison between the matching value and a designated value.

16. The operation method of claim 11, further comprising:
acquiring, by the processor, a matching value by inputting the feature information for the biometric authentication extracted from the encrypted biometric data to a model that is trained using the registered biometric data acquired from the memory; and
determining, by the processor, whether the biometric authentication is successfully performed based on a result of comparison between the matching value and a designated value.

17. The operation method of claim 11, further comprising:
requesting, by the secure processor, input of information for additional security authentication; and
in response to that the input information is identical to designated information, encrypting, by the secure processor, the biometric data.

18. The operation method of claim 11, further comprising:
determining, by the secure processor, whether a designated time has elapsed from a time at which the processor performs biometric authentication last; and
in response to determining that the designated time has not elapsed, encrypting, by the secure processor, the biometric data.

19. The operation method of claim 11, further comprising:
acquiring, by the processor, raw data related to the biometric data from the biometric sensor in the trust region; and
transmitting, by the processor, the acquired raw data related to the biometric data to the secure processor via the secure channel established between the trust region of the processor and the secure processor.

20. The operation method of claim 11, further comprising:
acquiring, by the secure processor, raw data related to the biometric data from the biometric sensor via the secure channel established between the biometric sensor and the secure processor; and
encrypting, by the secure processor, the acquired raw data related to the biometric data.
